(19) United States
(12) Patent Application Publication
(10) Pub. No.: US 2018/0182375 A1
(43) Pub. Date: Jun. 28, 2018

(54) METHOD, SYSTEM, AND APPARATUS FOR VOICE AND VIDEO DIGITAL TRAVEL COMPANION

(71) Applicant: Essential Products, Inc., Palo Alto, CA (US)

(72) Inventor: Yury Fomin, Pleasanton, CA (US)

(21) Appl. No.: 15/826,604

(22) Filed: Nov. 29, 2017

Related U.S. Application Data
(60) Provisional application No. 62/438,343, filed on Dec. 22, 2016.

(51) Int. Cl. G10L 15/00; G06F 17/28; G06K 9/00; G10L 15/26; G10L 15/25; G10L 15/22

(52) U.S. Cl. CPC G10L 15/005; G06F 17/289; G06K 9/00718; G10L 21/0208; G10L 15/265; G10L 15/25; G10L 15/22; G06K 9/00302

(57) ABSTRACT

The present invention contemplates a variety of improved techniques using a travel companion. The travel companion can include a headset, a user device, and the cloud. The headset can include a microphone, a speaker, and a camera which allows for collection of data. The travel companion can process the data and output results such as translation or other information based on data received.

### CLAIM FOR PRIORITY

This application claims priority to U.S. Provisional Patent Application No. 62/438,343 (Attorney Docket No. 119306-8039.US00), entitled “METHOD, SYSTEM, AND APPARATUS FOR VOICE AND VIDEO DIGITAL TRAVEL COMPANION,” by Fomin, and filed on Dec. 22, 2016. The content of the above-identified application is incorporated herein by reference in their entirety.

### TECHNICAL FIELD

The present invention relates to an assistant device and, more specifically, to WEARABLE ASSISTANT DEVICES.

### BACKGROUND

Within international travel and international business dealings, a language barrier often arises. Hiring human translators can be cost prohibitive, while translation dictionaries often cost the user a lot of time. The travel companion described herein provides users assistance in multi-language and foreign environments.

These and other objects, features, and characteristics of the present invention will become more apparent to those skilled in the art from a study of the following detailed description in conjunction with the appended claims and drawings, all of which form a part of this specification.

### SUMMARY

The present invention contemplates a variety of improved methods and systems for a wearable translation and/or assistant device. Some of the subject matter described herein includes a method for providing an audio communication via a portable device, comprising: detecting a first speech proximate to the portable device; generating a first video of the first speech being spoken proximate to the portable device; identifying a geographic location of the portable device; identifying a first content in the first speech using a speech recognition algorithm; identifying a second content in the first video using an image recognition algorithm; identifying a user profile associated with a user of the portable device by using the first content and the second content; using a predictive analytic model to determine a context using the first content, the second content, and the geographic location; determining a goal based on the context, wherein the goal represents the user's desired result related to the first speech, the first video and the geographic location; identifying a third content in the first speech using the speech recognition algorithm; identifying a fourth content in the first video using the image recognition algorithm; determining the audio communication responsive to the first speech based on the determined goal of the user, the third content and the fourth content; and providing the audio communication in a language preferred by the user based on the user profile.

Some of the subject matter described herein includes a method for providing a textual communication via a portable device, comprising: detecting a first speech proximate to the portable device; generating a first video of the first speech being spoken proximate to the portable device; identifying a geographic location of the portable device; identifying a first content in the first speech using a speech recognition algorithm; identifying a second content in the first video using an image recognition algorithm; identifying a user profile associated with a user of the portable device by using the first content and the second content; using a predictive analytic model to determine a context using the first content, the second content, and the geographic location; determining a goal based on the context, wherein the goal represents the user's desired result related to the first speech, the first video and the geographic location; identifying a third content in the first speech using the speech recognition algorithm; identifying a fourth content in the first video using the image recognition algorithm; determining the textual communication responsive to the first speech based on the determined goal of the user, the third content and the fourth content; and providing the textual communication in a language preferred by the user based on the user profile.

Some of the subject matter described herein includes a system for providing an audio communication via a portable device, comprising: a processor; and a memory storing instructions, wherein the processor is configured to execute the instructions such that the processor and memory are configured to: detect a first speech proximate to the portable device; generate a first video of the first speech being spoken proximate to the portable device; identify a geographic location of the portable device; identify a first content in the first speech using a speech recognition algorithm; identify a second content in the first video using an image recognition algorithm; identify a user profile associated with a user of the portable device by using the first content and the second content; use a predictive analytic model to determine a context using the first content, the second content, and the geographic location; determine a goal based on the context, wherein the goal represents the user's desired result related to the first speech, the first video and the geographic location; identify a third content in the first speech using the speech recognition algorithm; identify a fourth content in the first video using the image recognition algorithm; determine the audio communication responsive to the first speech based on the determined goal of the user, the third content and the fourth content; and provide the audio communication in a language preferred by the user based on the user profile.

### BRIEF DESCRIPTION OF THE DRAWINGS

FIG. 1a illustrates the headset with the attached directional microphone and camera;

FIG. 1b illustrates an embodiment in which the headset is a wearable device that includes one or more earbuds or headphones having one or more speakers, and a receiver device having one or more microphones and one or more cameras;

FIG. 2a illustrates the travel companion which includes a headset, a user device, and the cloud;

FIG. 2b illustrates an embodiment of the travel companion which includes the headset, including earbuds and receiver device, the user device, and the cloud;

FIG. 2c illustrates a flow diagram of an example of the travel companion providing a communication to a user;

FIG. 3a illustrates the use of a travel companion in a conference setting;

FIG. 3b illustrates the user of the travel companion, as described in FIG. 1b, in a conference setting;

FIG. 4a is a pictorial illustration of the voice training feature;

FIG. 4b is a pictorial illustration of the travel companion embodiments worn by users;

FIG. 5 is a pictorial illustration of a use of the travel companion while driving;

FIG. 6 is a pictorial illustration of a use of the travel companion in a museum setting;

FIG. 7 is a pictorial illustration of a use of the travel companion while walking;

FIG. 8 illustrates a flow diagram of an example of the translation operation in accordance with an embodiment;

FIG. 9 illustrates a flow diagram of an example of the prefetch operation in accordance with an embodiment;

FIG. 10 demonstrates a flow diagram of the travel companion communication in accordance with an embodiment;

FIG. 11 demonstrates an embodiment of audio recognition and visual recognition performed in parallel; and

FIG. 12 is a diagrammatic representation of a machine in the example form of a computer system.

### DETAILED DESCRIPTION

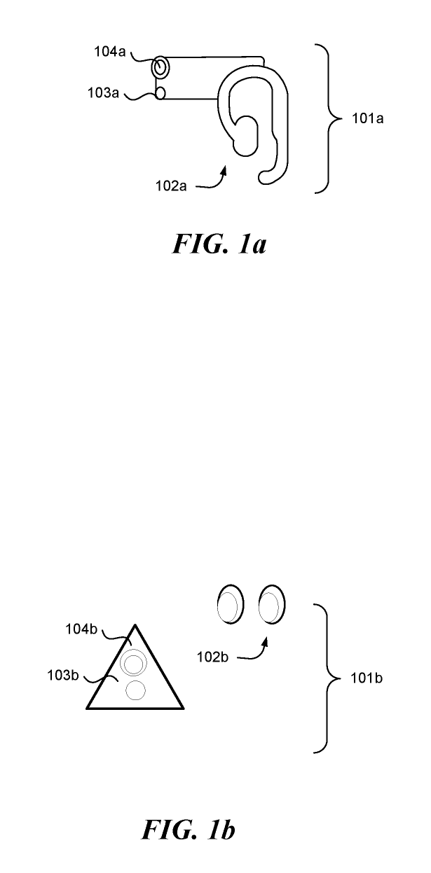

FIG. 1a illustrates an embodiment in which the headset 101a includes a microphone 103a, a camera 104a, and a speaker 102a. The travel companion can include the headset. In some embodiments, the headset may include a plurality of microphones, a plurality of speakers, and/or a plurality of cameras. In certain embodiments, the headset may be any wearable device, including an earpiece, glasses, hat, hair accessory, and/or watch. In at least one embodiment, the travel companion includes two headsets and/or a combination of wearable devices. The microphone can be a directional microphone. The camera can be a 205-degree camera and/or a 360-degree camera. In one embodiment, the microphone can be a stereo microphone. The speakerphone can be a stereo speakerphone. In an embodiment, the headset can be a telescopic headset that includes a microphone, a camera, and a speaker. The telescopic headset can include a rod attached to the camera and/or microphone. The rod can be manually or automatically adjustable. In certain embodiments, the headset may include the rod hidden in a wearable device such as an earpiece, glasses, hat, hair accessory, and/or watch.

FIG. 1b illustrates an embodiment in which the headset 101b is a device that includes one or more earbuds or headphones having one or more speakers 102b and receiver device having one or more microphones 103b and one or more cameras 104b. In an embodiment, wearable device can include one or more speakers 102b. The receiver device can be worn by the user. In an embodiment, the receiver device can be worn as a necklace, a broach, and/or another wearable alternative. The receiver device also can include an affixed and/or detachable stand, mount, hook, fastener, and/or clip which allows the device to be placed on a surface, affixed to an object and/or a wall, and/or be suspended from an object.

The camera and/or microphone can include a gyroscope allowing the camera and/or microphone to be adjusted vertically and/or horizontally. The camera and/or microphone can include a zoom and/or pivot feature. In an embodiment, the camera can be a gyroscopic camera and/or include a gyroscopic mount and/or gyroscopic stabilizer. The camera can be automatically or manually adjustable, vertically and/or horizontally. The camera may include a motion detection feature. The automatic adjustment process may include an algorithm designed to predict the movement of the user and/or target. In an embodiment, the user can select, via device or voice command, the target speaker and the camera and/or microphone can automatically adjust to follow the target speaker and/or target speakers. In an embodiment, the camera and/or microphone can be calibrated on a target using a user's voice commands, textual input, and/or by a selection on a camera feed on a device.

In one embodiment, the travel companion may provide translation of sound and/or video received by the user. The travel companion may gather information from the camera and/or microphone to identify speech. The travel companion can further be configured to translate the user's speech for others by outputting the translation via an external device such as a speaker or user device. The headset may communicate with a user device.

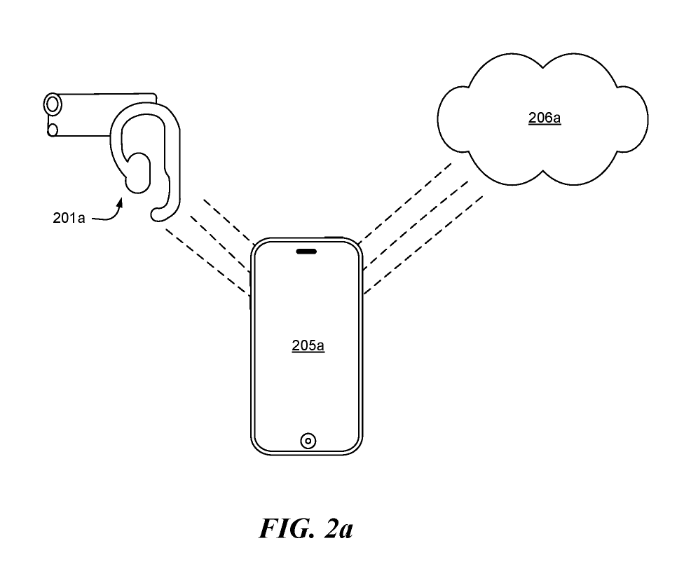

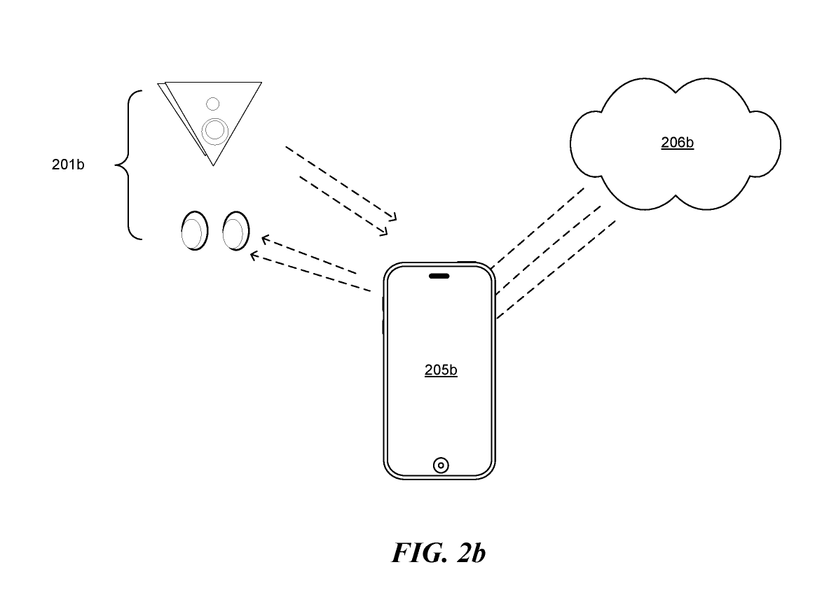

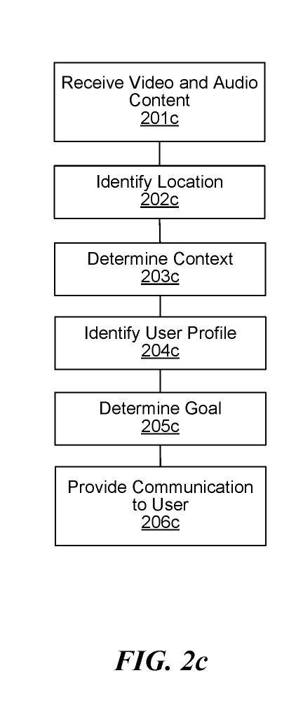

FIG. 2a illustrates an embodiment of the travel companion which includes the headset 201a, the user device 205a, and the cloud 206a. The headset 201a and user device 205a may communicate via communication technology, including short range wireless technology. In an embodiment, the communication technology can also be hardwired. The short range communication technology can include INSTEON, Wireless USB, Bluetooth, Skybeam, Z-Wave, ZigBee, Body Area Network, and/or any available wireless technology. The headset 201a and/or the user device 205a may connect to the cloud 206a via a communication technology.

FIG. 2b illustrates an embodiment of the travel companion which includes the headset 201b including earbuds and receiver device, the user device 205b, and the cloud 206b. The headset 201b and user device 205b may communicate via communication technology, including short range wireless technology. The earbuds can receive communication from the user device 205b and the receiver device can send communication to the user device. In an embodiment, the receiver device can receive and/or send communication to the user device. The communication technology can be hardwired and/or wireless. In at least one embodiment the wireless communication technology can include a short range communication technology. The short range communication technology can include INSTEON, Wireless USB, Bluetooth, Skybeam, Z-Wave, ZigBee, Body Area Network, and/or any available wireless technology. The headset 201b and/or the user device 205b may connect to the cloud 206b via a communication technology.

The user device can include a portable mobile device, a phone, a tablet, and/or a watch. The user device may store the digital travel companion app. The app can include travel companion settings, profile settings, a configuration feature, a security feature, authentication, and/or command features. The travel companion app can be a software application stored on the user device. The user device may store profile information, including participant speaker profile information, environment profile information, and/or situation profile information. In some embodiments, the app and/or profile information is stored on a cloud device, an external device, a user device, and/or headset. The profile information may be preconfigured, configured by the user, and/or created automatically. The automatic profile information creation can be performed using machine learning. The profile information creation can incorporate information gathered using the camera, speaker, and/or microphone. The profile information can be used to determine the settings of the travel companion.

In one embodiment, the headset can collect data, process the voice/speech recognition on the user device, and then process the translation on the cloud. In one embodiment, the headset can collect data and transmit the data to the user device; the user device can then transmit data to the cloud, which processes the speech/voice recognition and translates the data. The user device, the headset, or another device can receive the translation information from the client and output the translation results to the headset, user device, or another device. The translation results may be auditory or textual.

The headset can collect data, process the voice/speech/sound recognition on the user device, and process the information to determine the next step, which is whether to provide information to the user. In one embodiment, the headset can collect data and transmit the data to the user device; the user device can transmit data to the cloud, which processes the speech/voice/sound recognition and outputs a result. The user device, the headset, or another device can receive the result information from the client and output the result to the headset, user device, or another device. The result may be auditory and/or textual.

FIG. 2c illustrates a flow diagram of an example of the travel companion providing a communication to a user. In at least one embodiment, the video and audio content can be received 201c. Additionally the location of the travel companion can be identified 202c. In some embodiments a location can include the geographical location based on a GPS, a Wi-Fi positioning system, audio data, video data, or combination thereof.

In some embodiment the video content, the audio content 201c and/or location 202c can be used to identify the context 203c. The context can represent information about the immediate environment, such as whether the user is at a conference, in the street, in a foreign country, etc. This information can be identifying using a predictive model. In some embodiments multiple contexts can be identified. For example when a user is in a conference room in a museum in France that the context can be identified a museum, conference, and foreign country. In the context it can further be analyzed using the profile of the user 204c, the video content, the audio content, and/or location information to determine the goal of the user 204. The goal can be identified using one or more modeling and/or artificial intelligence algorithms. In the example, the goal can be identified as translation of foreign speech in conference room.

A communication to a user 206c can be provided based on the video content, audio content, location, determined context and/or determined goal. In an example when the goal of the user is identified as translation of foreign speech in the conference room. The languages spoken by the user can be identified. The languages spoken by the user of the travel device can be identified using a user profile. The travel companion can then use the video content, audio content, and/or location to determine the portion of the speech in the conference room (audio content and/or video content) which is foreign to the user. The portion of speech foreign to the user can be translated and provided to the user in the language understood by the user 206c. In some embodiments the translation can be provided via a textual communication by sending this textual information to a device such as a mobile phone.

The travel companion can analyze one or more environmental variables, and/or situational variables and can determine the use case. For example the travel companion when turned on by a driver while driving a car can determine that the road signs in front of the driver are in the language not spoken by the driver. The travel companion can set the context to “driving in a foreign country” and goal to “translation of signs” In another example the travel companion can identify that it is at a meeting using the video and/or audio feed, then can identify that some of the individuals at the meeting are speaking in a language not spoken by the user and can therefore set the contexts to “translate at a meeting.” In an example, a travel companion can identify that it is in a foreign country and the user is walking on a street, in response the travel companion can identify the context as “walking tourist” and goal as “translate foreign words directly spoken to the user.”

Information about any environment, situations and/or individuals in the environment can be used to identify the context and/or goals. The identified context can be associated with the behavior of the travel companion. For example if the travel companion determines that the context is “tourist” then travel companion can be set to provide translations to the user only of speech spoken while facing the user, in other words, the travel companion can be set to not translate the speech spoken around the user that is not directed at the user. In another example, the travel companion determines it is in a conference setting based on the video, audio and/or location information, the travel companion can provide translation of all spoken language which the user cannot understand.

In at least one embodiment the response of the travel companion to a specific content can be adjusted based on the user profile. The user profile can include information about the user such as the preferred speed of the generated translation, the languages understood by the user, the dialects of the language spoken by the user, affinity toward profanity (e.g., translating curse words, not translating curse words), and the detail of the preferred translation (e.g., summary of translation, translation of all spoken words, etc.). For example in a conference context the travel assistant can be set to translate only the speech in a language not spoken by the user and not to translate profanities.

The travel companion can be configured to store or not store recordings of the video and/or audio. The travel companion may use one or more caches configured to store data. The travel companion may include a feature which purges the cache. The cache can be set to purge after a specific amount of time. The cache and storage can be configured to comply with national or international privacy laws, such as US wiretapping laws. In at least one embodiment, the storage behavior can be correlated to the privacy laws in the identified locations. For example, if it is identified that the user is in California which is a two consent jurisdiction, the travel companion can automatically change the settings to not store the content. Furthermore in at least one embodiment the travel companion can monitor for consent of all talking parties and store the content after the consent is given. The travel companion can be configured to only store content of the parties who consented and not store the content of the parties who have not given consent. In at least one embodiment the travel companion can be configured to store the video and/or audio temporarily based on context and/or user profile. In at least one embodiment the determination as to whether the video and/or audio is stored can depend on the location, environment and/or individuals involved. For example, in a locality where recording is illegal, the travel companion can determine not to store audio and/or video. In another example, the travel companion can be configured to only record audio and/or video when the involved individuals have given consent in the past to the recording.

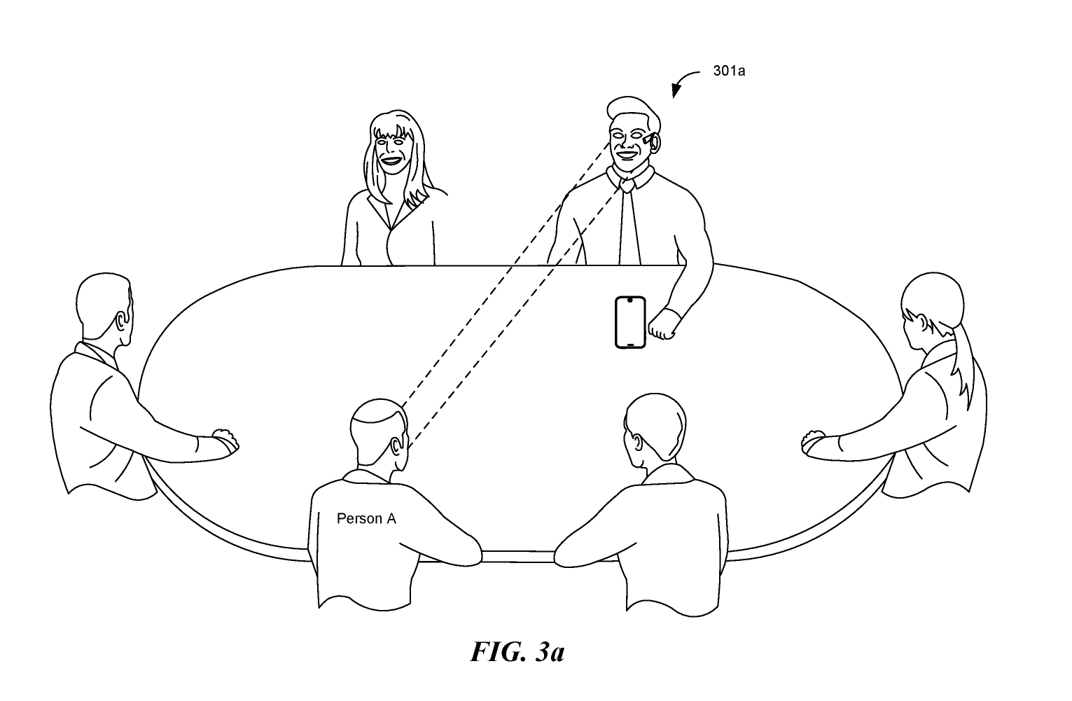

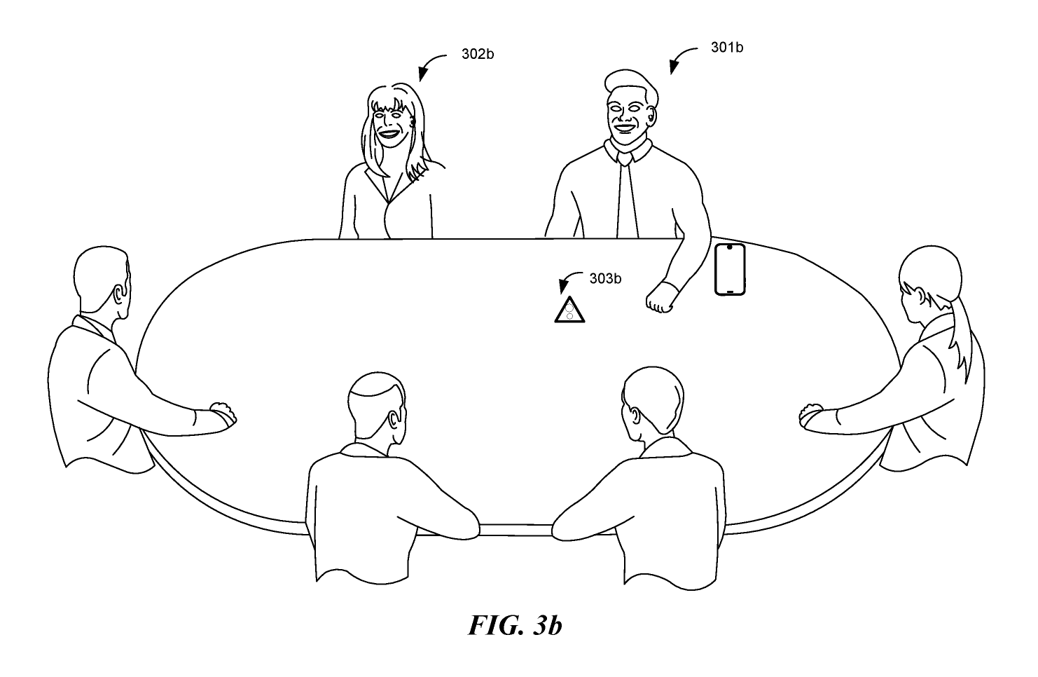

FIG. 3a illustrates the use of the travel companion, including the headset 301a in a conference setting. In the example, a user is at a conference table; the user using the travel companion and headset 301a understands the languages spoken by all participant speakers except person A. The travel companion can be configured to translate the information spoken by only person A. An embodiment may include isolating and translating only the words spoken by the voice of person A. This may be accomplished using the participant speaker profile. The travel companion may translate only the words spoken by person A by isolating the language spoken. This may be accomplished through the user profile identifying the languages spoken by the user.

In at least one embodiment the user profile can include the preferred speed of translation speech relay (e.g., 120 words per minute, 200 words per minute, etc.). The travel companion can monitor user response to the translation speech relay (e.g., the speech generated by the travel companion representing the translation) and dynamically adjust the preferred speed. Factors when considering the preferred speed include user's body language, micro-expressions, and user commands to repeat translation speech relay. In at least one embodiment the preferred speed is adjusted for environmental conditions. For example, the preferred speech can be adjusted to a slower speech when a user is in a loud environment and adjusted to a faster speech when a user is in a quite environment.

In at least one embodiment the user's regional dialect is stored and the language is translated in accordance with the regional dialect. The user's regional dialect can be identified by the speech of the user. For example, if the travel companion identifies that the user uses words such as “bodega” and “scallion,” the travel assistant can determine that the user's regional dialect is a New York dialect and in response can provide the translated speech to the user using the New York dialect. In at least one embodiment, the travel companion can translate the regional dialects. For example if the travel companion identifies that the user speaks a New York dialect, and is speaking to a person A who is using a southern American English dialect then when the person A says “please buy an alligator pear from the store,” the travel companion can identify that the term “alligator pear” is unique to the Southern American English dialect and provide the translated term “avocado” to the user. In at least one embodiment, when translating between dialects the travel companion can be set to only translate words that are unique to the dialect and not all spoken words. For example, when person A tells a user “do you know the directions to the davenport store” the travel companion can transmit only the relevant translation to the user, for example “the word davenport means sofa.” In at least one embodiment the travel companion can collect user response and based on the response determine whether to translate the term to the regional dialect. The user response can be collected by selecting user's biometrics, body language and/or micro-expressions. In an example, when person A tells a user “do you know the directions to the davenport store” the user's response can be identified as the word being familiar to the user and the travel companion can determine that the word “davenport” is familiar to the user and therefore does not need to be translated.

FIG. 3b illustrates the use of the travel companion, including the travel companion as described in FIG. 1b in a conference setting. In the example, the receiving device 303b of the headset is placed on the conference room table. The four earbuds of the travel companion are used by two users 301b and 302b using the travel companion. The user 301b may configure the travel companion to translate specific languages and/or information spoken by a specified individual. Similarly, the user 301a may configure the travel companion to translate specific languages and/or information spoken by a specified individual. The travel companion can be configured to deliver different information to multiple users; this can be configured using the user profile.

The travel companion can translate, to one or more users, everything said by participant speakers, the voices of only identified participant speakers, and/or a specific language and/or set of languages. In at least one embodiment, a user can configure the device to identify the languages spoken by the user and to only translate the languages the user does not understand; the user profile information may be used to determine the languages spoken by the user. The information gathered from the camera and/or microphone can be used to distinguish participant speakers and/or languages. The data gathered from the camera can be used to determine the person speaking. The information gathered from the camera and/or microphone can be used to facilitate speech recognition by utilizing camera data to determine lip movements, facial movements, and/or body movements.

In at least one embodiment, the travel companion can include a feature which translates the words of the user and provides an audio translation. The audio translation can be output by the user device, the headset, or an external device such as a speaker.

In at least one embodiment, the travel companion can be configured for a deaf user and can transcribe the words spoken using audio and/or visual input. The travel companion can display the transcription results on the user device and/or an alternate device.

In at least one embodiment, the travel companion can include a noise cancellation and/or noise reduction feature. The audio input can be filtered to suppress the background noise and enhance the audio which is output to the user via the headset speaker. The process to enhance the audio output can include digital signal processing (DSP). Additionally, the process to enhance the audio output can include analyzing visual input. The analysis of visual input can include an automatic lip-reading algorithm. The lip reading algorithm can include facial analysis.

The travel companion device can be configured to repeat to the user enhanced audio and/or translated audio. The repeat feature can be initiated by a user's voice command, by a button on the user device or headset, and/or via software.

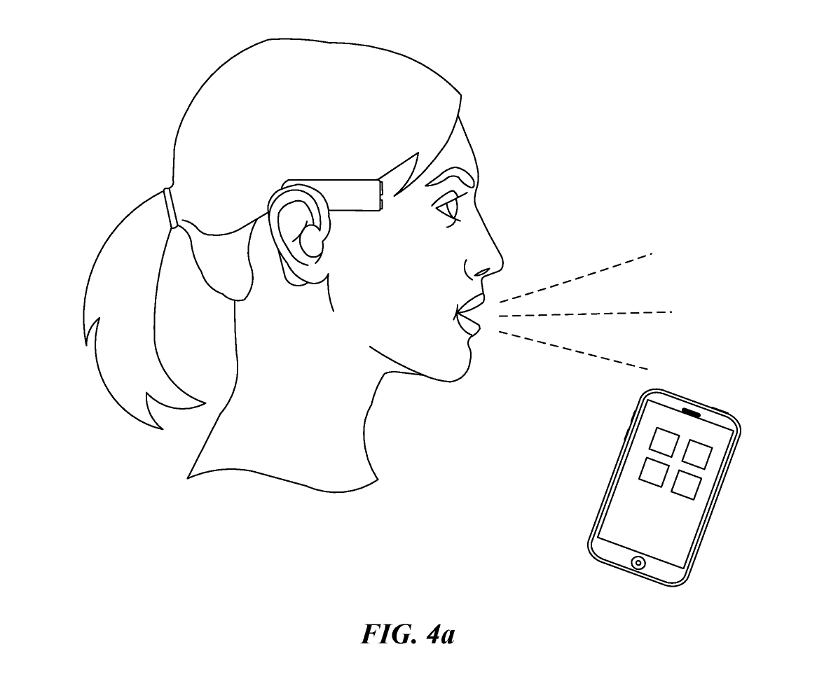

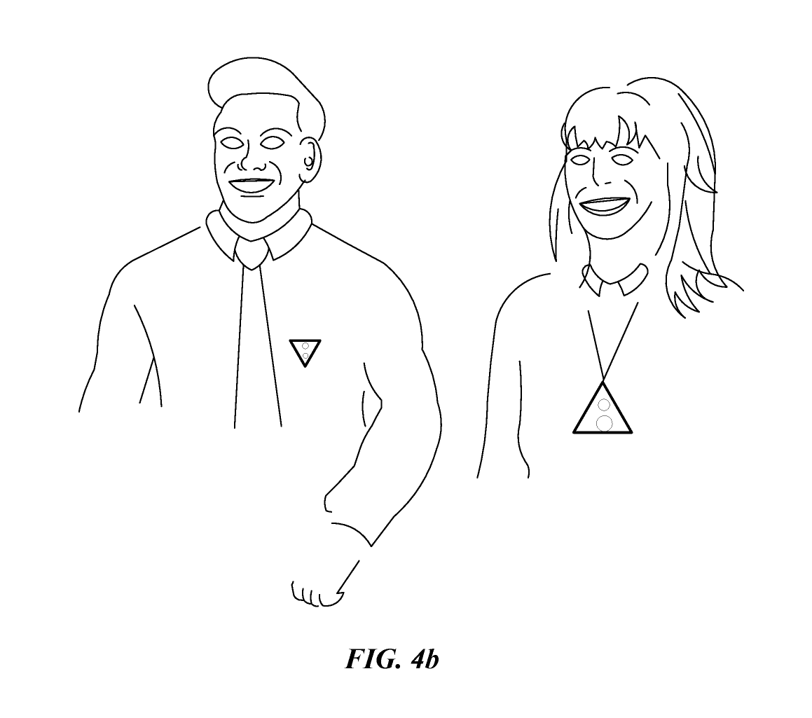

FIG. 4a is a pictorial illustration of the travel companion in use, the profile setup displayed. In at least one embodiment, the user's voice can be recognized. The user profile can be set by having the user train the system to recognize the user's voice. The environmental profile can be configured to determine environmental sounds. The environmental profile can be used to determine which sounds to filter and/or to identify the environment in the future.

FIG. 4b is a pictorial illustration of the travel companion embodiments worn by users. In an embodiment, the receiver device can be worn as a pin and/or broach. In at least one embodiment, the receiver device of the travel companion can be worn as a necklace.

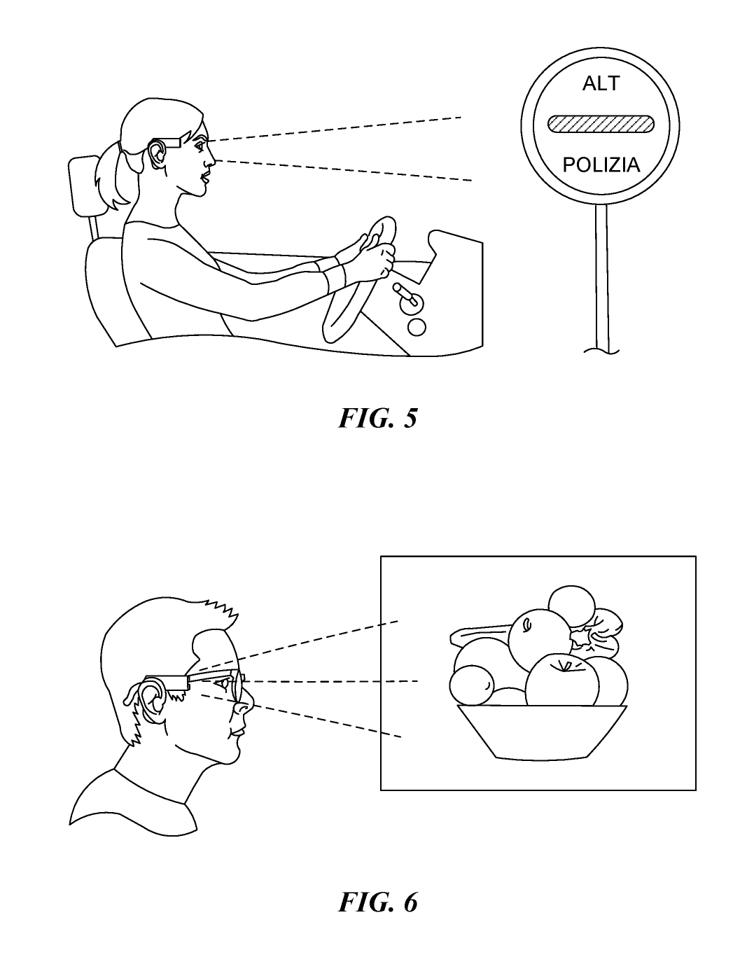

FIG. 5 is a pictorial illustration of a use of a headset while driving. This example demonstrates the use of a headset while driving in a foreign country. The travel companion can identify signs in a foreign language and translate the signs to the user. The user can manually set the environment profile to, for example, “Driving in Italy,” or the system can automatically determine the environmental profile to use based on a mix of available data such as GPS, geolocation, location, audio, video, and/or recognized text. The environment profile can include information such as information the user would like translated. The travel companion may determine the settings based on detected spoken or written language; for example, a sign in the Cyrillic alphabet can be used to determine the user is in a Russian environment. In one embodiment, the determination that a user is in a specific environment may cause the user device to download the corresponding language profile or relevant objects so that translation, speech to text, image recognition, or textual image recognition can be processed on the user device. Additionally, the determination that a user is in a specific environment may cause the cloud to cue the corresponding language or relevant objects so that translation, speech to text, image recognition, or textual image recognition can be processed.

In an embodiment, the user may set the travel companion to translate signs but not audio. This feature can be valuable when a user is driving and listening to the radio. The words on the sign can be translated and/or the meaning of the sign can be translated.

The travel companion may record video and/or audio. The travel companion can be set to record when specific profiles are enabled. A user can initiate recording via voice command, by a button on the headset or device, automatically based on a profile, via a trigger, or by software and/or an application. The recording can be recorded in intervals and/or on automatic loop. The recording can be stored remotely, on the user device, on the cloud, and/or on the headset.

In at least one embodiment, the travel companion can assist the user with directions. The travel companion can be connected a mobile device such as a mobile phone and can transmit directions to the user from the mobile device. In at least one embodiment where directions are provided to the user, the assistant device can determine that the directions are complex (e.g., above a threshold number of steps, micro-expressions of the user showing frustration, etc.) and store the directions allowing the user to playback the direction upon request. For example if a user asks a pedestrian “how do I get to the MET?” and the pedestrian responds “you make a right on 3rd avenue, make a left on 62nd street then a right on 5th avenue, the museum will be on your left side right after east 80th St.” The travel companion can determine that these directions are complex and save the recording of the directions which can be played back by the user.

In at least one embodiment, the travel companion automatically begins recording once it identifies that a user is asking for directions. Depending on the response to the direction, the travel companion may determine that the directions are complex and store the directions. The complexity of directions can be identified by the length of directions, number of steps, the detail of description, and/or the indicators of user frustration (e.g., micro expressions and/or body language). In at least one embodiment the directions provided to the user can be superimposed onto a map and provided to the user via a device with the screen such as glasses and/or mobile phone. In at least one embodiment, the directions can be provided to a user's mobile device in text form, and/or transmitted to a map application of the user device.

FIG. 6 is a pictorial illustration of a use of the travel companion in a museum setting. The travel companion can be set to identify the environment or context manually or automatically. In the example of the user in the museum, the environmental profile or context can be set to “Museum.” It can also be set to “Museum of Modern Art.” The camera on the headset may provide visual data that identifies the art object at which the user is looking. In the specific example, the travel companion can identify the art in front of the user. The travel companion can be set to provide information to the user about an object, such as the name of the art piece, its history, and/or other information. In an embodiment, the travel companion can transmit the received and/or transcribed information to an application, a service, and/or a computing device. In an example, a user visiting a museum may set the travel companion to transmit the video and/or audio to a social media platform, thereby sharing the experience with family and friends.

The travel companion can determine the settings of translation based on information such as the user profile information, participant speaker profile information, environment profile information, and/or situation profile information. The travel companion can determine information based on data collected using the headset, the user profile information, participant speaker profile information, environment profile information, and/or situation profile information. The headset may provide visual information to the mobile device and allow the user to select one or more objects and/or one or more people as the source to be translated.

In at least one embodiment the travel companion can curate one or more art pieces. The travel companion can initiate the curation feature once it identifies the user being in a museum environment. In at least one embodiment this determination can be made by analyzing the video feed from the camera associated with the travel companion. For example if the video feed includes a plurality of paintings and/or a sign indicating a museum, the travel companion can automatically identify that the user is in a museum. In at least one embodiment the profile associated with the travel companion can be updated to a museum profile. In at least one embodiment location information can be used to determine the location of the user associated with the travel companion.

In some embodiments, the curation feature can provide information to the user about the art which the user is facing. The art which the user is facing can be identified by analyzing the video feed, location information, and/or blueprint information associated with the museum. For example the user's location can be identified using the GPS. In the example, the user location can indicate that the user is inside the Museum of Modern Art in New York, the museum schematics in conjunction with location information can be used to determine the art which the user is facing.

The travel companion can provide information to the user about the art. The travel companion can provide recommendations for the user (e.g., tourist sites, specific exhibits, specific paintings, etc.). In some embodiments the travel companion learns about the user using one or more machine learning algorithms to determine the preferred art and guides the user to the art which the user is predicted to prefer. The travel assistant can also ask the user to provide ratings of the art viewed and this information can be used to determine the art which the user is likely to prefer. Other factors to determine user preferences can include user characteristics such as age, country of origin, profession, interaction history with the travel companion and/or user gender. For example if it is determined that a user prefers impressionists painters the travel companion can guide the user to impressionists painters such as Edouard Manet and Edgar Degas. Guiding the user can include providing instructions (audio, textual, etc.) to the user such as “to see the Impression Sunrise by Claude Monet make your next right.”

In at least one embodiment the user preference can indicate the level of detail about the art to provide to the user. Furthermore the user preference can indicate the information (i.e., painter's life, historic events in the period during which the art was created, the materials used to create the art, etc.) that the user may find interesting about the art. The user preference can be measured by the user response to the curation. For example, the travel companion can identify user frustration via a camera body language and/or micro expressions such as an eye roll, squinting of the eyes, tensing of the lips, movement of the nose, movement of an eyebrow, a hand motion, and/or breathing pattern. In response to the provided generation information that travel companion can monitor the user's response and record the user's response in Association with the information provided at the time of users response. This information can be used to determine user preference. As the user responses are collected, the user preference can be dynamically updated. In at least one embodiment, the user profile is dynamically updated as information is collected. The information collected and used to update the user profiles can include preferences of users based on micro-expression of the user, user instructions, languages know by the user, and/or interactions of the user with others.

In at least one embodiment the travel companion keeps track of the art previously curated and/or seen by the user and provides for relative information between multiple art pieces. For example the travel companion can indicate that the user “painting A which you are looking at was painted in the same year and in the same country as a painting B which you saw a few minutes ago.”

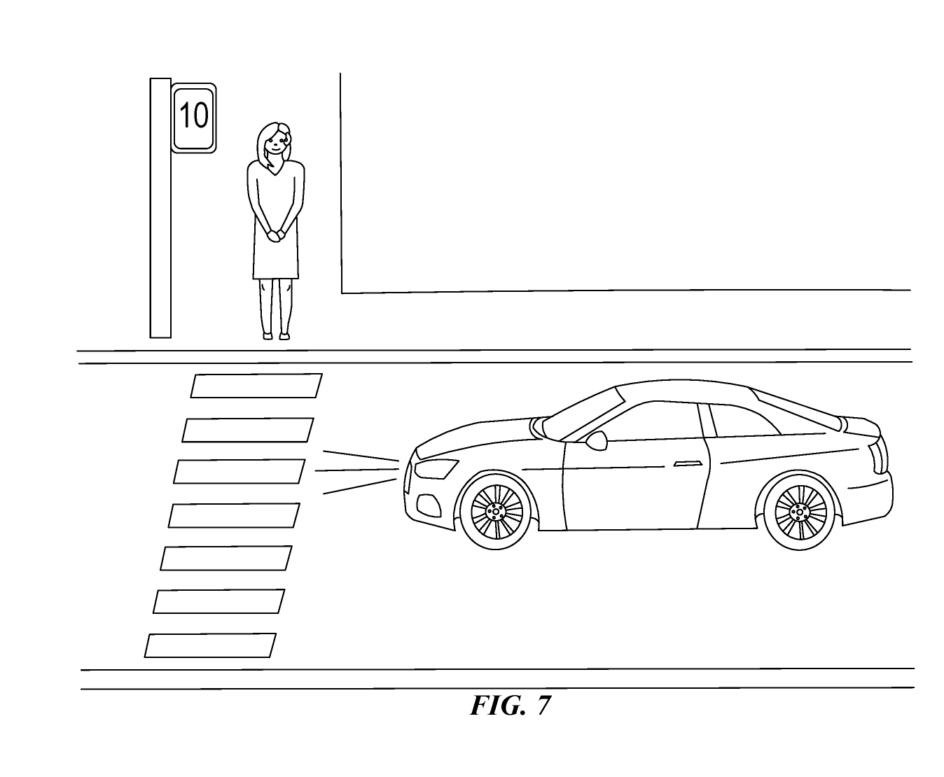

FIG. 7 is a pictorial illustration of a use of the travel companion while walking. The travel companion may process visual and/or audio data. The travel companion can be set to provide an alert to the user. For example, a user standing at a cross walk may have the right of way because the crossing sign is illuminated green; however, a car approaching at a fast speed toward the crosswalk may trigger the travel companion to warn the user of the potential danger. The combination of camera and/or microphone data may be compiled to determine whether an alert is required. The travel companion can be configured to describe the surrounding environment to the user. This is especially helpful when the user is visually impaired.

In an embodiment, the travel companion can be configured for blind users. The travel companion can use a GPS, a map feature, and/or other tools that are used in combination with audio and/or video feed to provide instructions for a user. The instructions can include step by step walking instructions and/or obstacle alerts. The instructions can be delivered to the user via audio.

The travel companion can also translate documents. The user may select a visual text, such as a contract. The user can select the text by a verbal command, a hand gesture, and/or by manually selecting this feature using the user device or headset. The travel companion can provide translated text either by auditory or textual output. A feature of the travel companion can include recording video, audio, and/or still photographs.

The travel companion can be prompted by the user to translate a specific word and/or phrase. For example, the user can prompt the travel companion to translate the phrase “je m'appelle” using a specific command, such as, “travel companion, please translate ‘je m'appelle.’”

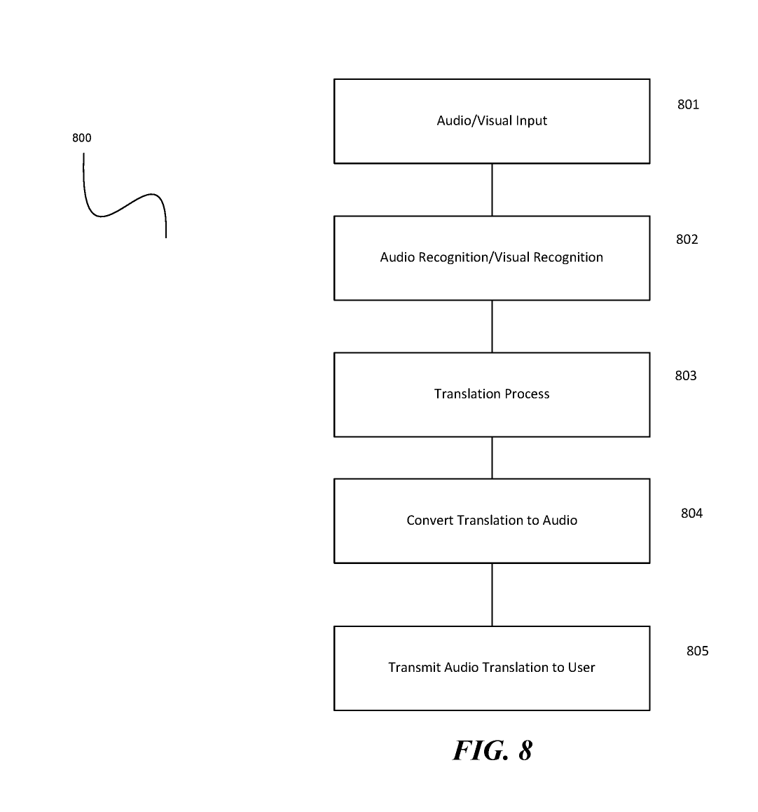

FIG. 8 illustrates a flow diagram of an example translation operation in accordance with an embodiment. In the diagram 800, the audio and visual input of step 801 is received from the headset and transmitted to the user device. In step 802, the user device processes audio and visual recognition. Step 802 can be done on the user device, and in some embodiments, it can be performed on the headset, a computer, and/or the cloud. Step 803 receives the results of step 802 and processes a translation. The translation process can include translating the audio to another language, translating physical movements including lip and hand movements, and/or situational analysis. The translation process can be implemented on the cloud, a remote computer, the user device, and/or the headset. The relevant files can be prefetched or preloaded by a cloud device, remote computer, the user device, and/or the headset based on the information gathered in steps 801 and/or 802. In step 804, the translation data is converted to audio by the cloud device, remote computer, the user device, and/or the headset. In step 805, the translation audio is transmitted to the headset. In at least one embodiment, the information derived from the translation step is converted to visual or textual information and is displayed to the user on the user device and/or a computer.

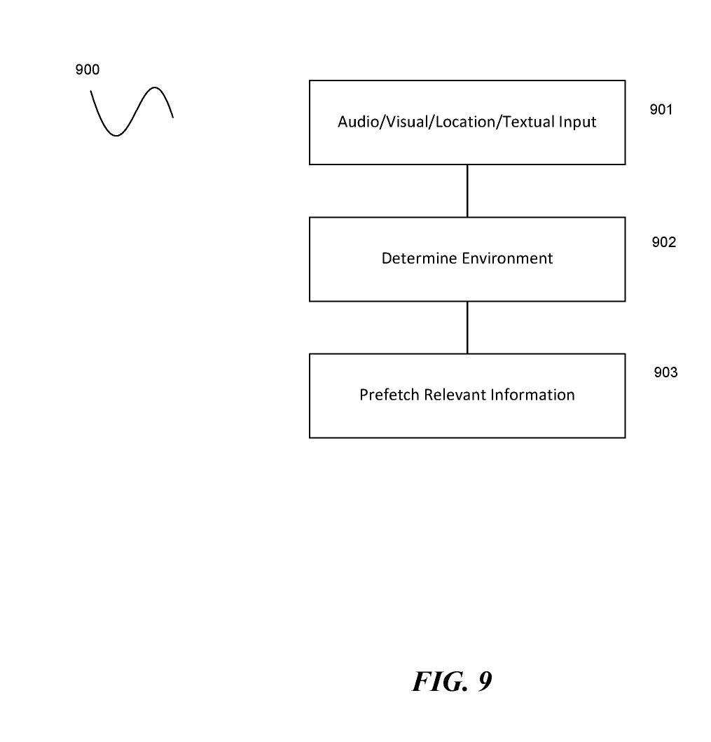

FIG. 9 illustrates a flow diagram of an example of the prefetch operation in accordance with an embodiment. In the diagram 900, audio, visual, location, and/or textual input is received in step 901. The information gathered in step 901 is then used to determine the environment in step 902. The environment can be associated with an environment profile. The environment can be determined based on location, visual, textual, or audio information. In one embodiment, determining the environment can include determining the language from which information is to be translated. The information gathered in step 902 is then used to prefetch relevant information and/or files used in the translation feature in step 903. The prefetch feature allows for an increase in processing speed because the relevant data required to perform the translation is available. For example, if it is determined that the user is in an Italian environment, the prefetch feature loads the relevant information required for an Italian translation, thereby increasing the processing speed.

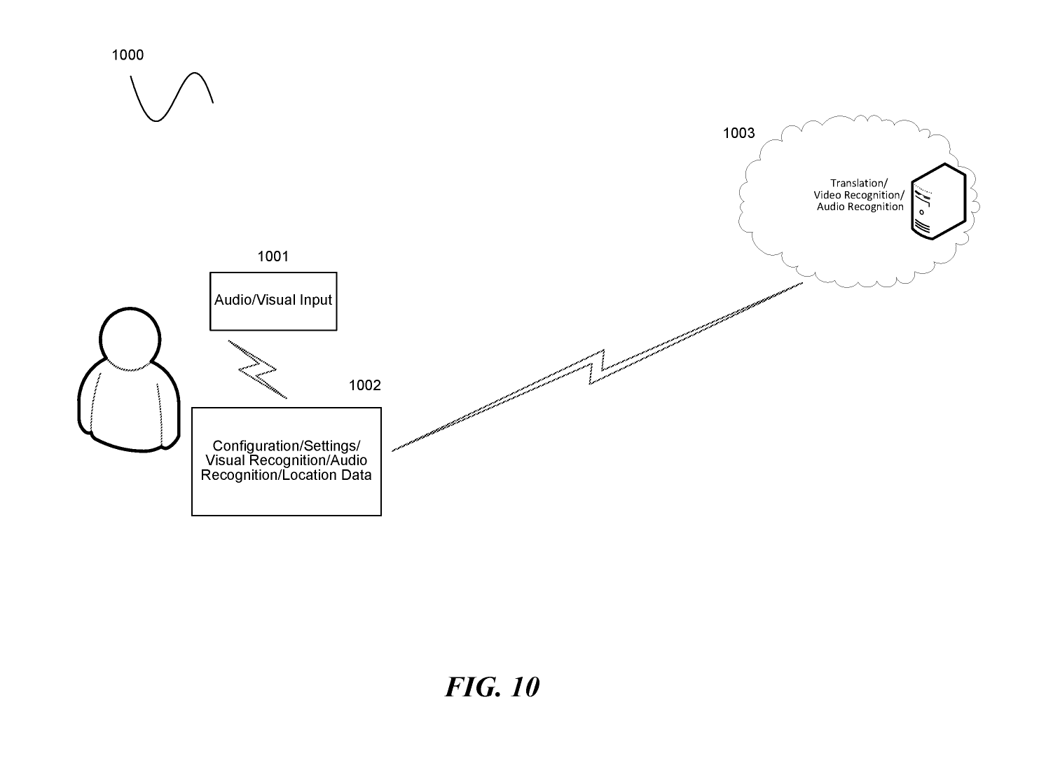

FIG. 10 demonstrates a flow diagram of an embodiment. In the diagram 1000, visual and audio information input is received from the headset in step 1001. The input information is sent to the user device via a wireless connection in step 1002. The user sets the configuration and/or settings on the user device. The information of step 1001 is received at the user device and processed in accordance with the configuration and/or settings. The information processing can include visual recognition, audio recognition, OCR, and location determination (including geolocation). The information of step 1002 is then transmitted to the cloud in step 1003, where translation, visual, and/or audio recognition can be performed in one embodiment.

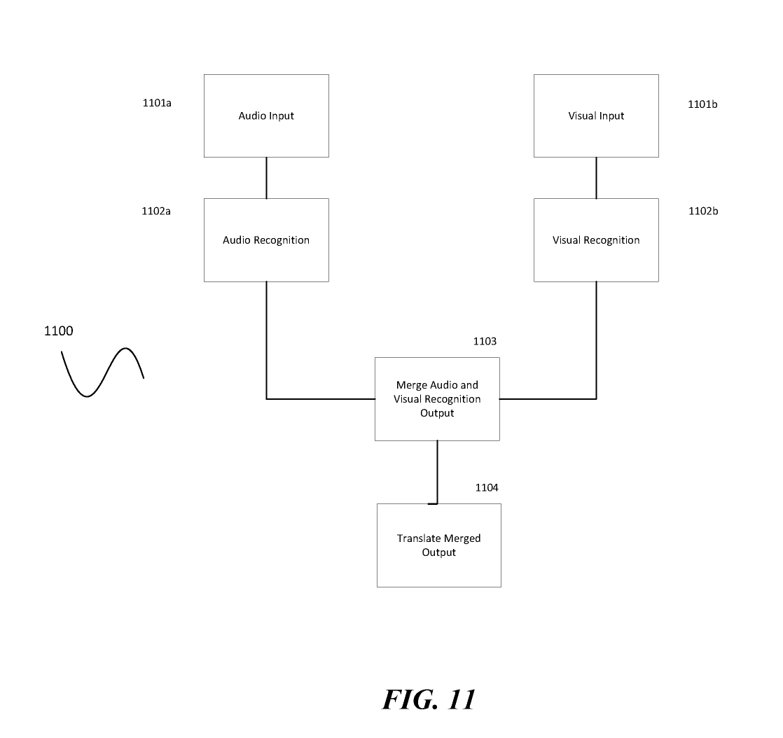

FIG. 11 demonstrates an embodiment of audio recognition and visual recognition performed in parallel. Audio input data is received in step 1101a, and audio recognition is performed at step 1102a. In some embodiments, the input of steps 1101a and 1101b is collected via the headset. In at least one embodiment, the input of steps 1101a and 1101b is collected via the user device or another device. In the illustration of diagram 1100, audio recognition 1102a processes the audio input 1101a. In the illustration of diagram 1100, visual recognition 1102b processes the visual input 1101b. The visual recognition 1102b may include recognizing detailed movements of the mouth area, upper lip, lower lip, upper teeth, lower teeth, tongue, facial expression, hand gestures, sign language, and/or nonverbal cues. The visual recognition 1102b feature may include determining spoken words, subvocalized words, gestured words, and/or context of the spoken words. The audio recognition 1102a process may include using one or more techniques, including techniques based on Hidden Markov Models, Dynamic time warping, neural networks, deep feedforward, and recurrent networks. The steps of 1102a and 1102b can be performed by the user device and/or by the cloud. In some embodiments, the steps of 1102a and 1102b are performed at least partially by the headset.

At step 1103, the audio and visual recognition output is merged. The merge can use the timestamps of the input to synchronize the results of steps 1102a and 1102b. In at least one embodiment, the merging step includes an assigned priority of the accuracy of results for steps 1102a and/or 1102b. For example, a higher priority can be assigned to the audio output so that when there is an output conflict, the conflict is resolved in favor of the audio output. In an embodiment, a higher priority can be assigned to visual input; thus, when there is an output conflict, the conflict can be resolved in favor of the visual input. The priority assigned to the outputs can be configured per the profile of the speaker, the profile of the user, or the environment profile. Additionally, the priority assigned to the output can be determined by assessing the quality of the audio or visual input, in accordance with an embodiment described in the diagram 1100. Quality can be determined by the lighting conditions of the visual input, the background noise in the audio input, and/or the number of speakers. In some embodiments, the priority is assigned to individual sections of the output. In an example, when a speaker's speech is clear, the priority is set higher for audio, except for a section of the audio where a car alarm in the background has obstructed the sound clarity. In this example, the audio section with an obstructed sound can be assigned a low priority, and recognition results 1102a and 1102b can be merged in step 1103 and resolved to favor the visual for that section. This feature allows both the audio and visual input to be used simultaneously to complement each other and thus compensate for a lack of information provided by one or the other.

At least one embodiment includes step 1102b only being performed for sections where the audio input 1101a is determined to be of low quality. The sections with low quality may occur when a noisy environment or audio dropouts are identified. This allows for accurate transcription when the audio is not audible and the lip movements are used to supplement the audio gap. The merge operation may be performed by the user device and/or by the cloud. In at least one embodiment, the merge operation is performed at least partially by the headset. At step 1104, the output is translated. In at least one embodiment, the merged output can be textually displayed to the user, translated in step 1104, and/or output to the user via the headset speaker.

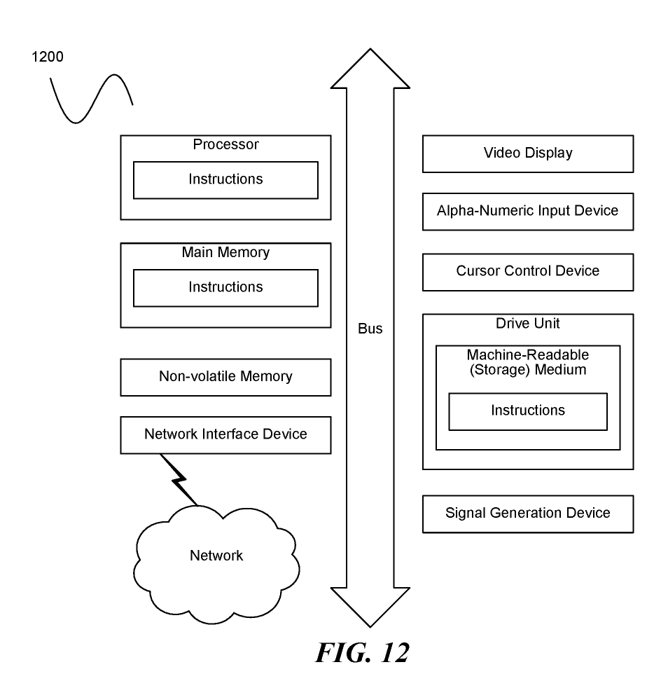

FIG. 12 is a diagrammatic representation of a machine in the example form of a computer system 1200 within which a set of instructions, for causing the machine to perform any one or more of the methodologies or modules discussed herein, may be executed.

In the example of FIG. 12, the computer system 1200 includes a processor, memory, non-volatile memory, and an interface device. Various common components (e.g., cache memory) are omitted for illustrative simplicity. The computer system 1200 is intended to illustrate a hardware device on which any of the components described in the example of FIGS. 1-11 (and any other components described in this specification) can be implemented. The computer system 1200 can be of any applicable known or convenient type. The components of the computer system 1200 can be coupled together via a bus or through some other known or convenient device.

This disclosure contemplates the computer system 1200 taking any suitable physical form. As example and not by way of limitation, computer system 1200 may be an embedded computer system, a system-on-chip (SOC), a single-board computer system (SBC) (for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1200 may include one or more computer systems 1200; be unitary or distributed; span multiple locations; span multiple machines; or reside in a cloud, which may include one or more cloud components in one or more networks. Where appropriate, one or more computer systems 1200 may perform without substantial spatial or temporal limitation one or more steps of one or more methods described or illustrated herein. As an example and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 1200. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing an entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1200. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 12 reside in the interface.

In operation, the computer system 1200 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer's memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

I/We claim:

1. A method for providing an audio communication via a portable device, comprising:
detecting a first speech proximate to the portable device;
generating a first video of the first speech being spoken proximate to the portable device;
identifying a geographic location of the portable device;
identifying a first content in the first speech using a speech recognition algorithm;
identifying a second content in the first video using an image recognition algorithm;
identifying a user profile associated with a user of the portable device by using the first content and the second content;
using a predictive analytic model to determine a context using the first content, the second content, and the geographic location;
determining a goal based on the context, wherein the goal represents the user's desired result related to the first speech, the first video and the geographic location;
identifying a third content in the first speech using the speech recognition algorithm;
identifying a fourth content in the first video using the image recognition algorithm;
determining the audio communication responsive to the first speech based on the determined goal of the user, the third content and the fourth content; and
providing the audio communication in a language preferred by the user based on the user profile.

2. The method of claim 1, wherein the audio communication is a translation of the third content.

3. The method of claim 1, wherein the context is a conference.

4. The method of claim 1, further comprising determining a fifth content using the first video and adjusting the audio communication responsive to the fifth content.

5. The method of claim 4, wherein the fifth content includes a micro-expression of the user.

6. The method of claim 5, wherein the adjusted audio communication includes repeating a portion of the audio communication responsive to the micro-expression.

7. The method of claim 5, wherein the adjusted audio communication includes updating the user profile responsive to the micro-expression.

8. The method of claim 5, wherein the adjusted audio communication includes adjusting a speed of audio communication responsive to the micro-expression.

9. The method of claim 1, wherein the context is a museum, and the goal is to hear a curation of art.

10. The method of claim 1, wherein the context is determined by identifying a speaker of the first content.

11. The method of claim 1, wherein the audio communication is determined by the fourth content being used to supplement distorted audio in the third content.

12. A method for providing a textual communication via a portable device, comprising:
detecting a first speech proximate to the portable device;
generating a first video of the first speech being spoken proximate to the portable device;
identifying a geographic location of the portable device;
identifying a first content in the first speech using a speech recognition algorithm;
identifying a second content in the first video using an image recognition algorithm;
identifying a user profile associated with a user of the portable device by using the first content and the second content;
using a predictive analytic model to determine a context using the first content, the second content, and the geographic location;
determining a goal based on the context, wherein the goal represents the user's desired result related to the first speech, the first video and the geographic location;
identifying a third content in the first speech using the speech recognition algorithm;
identifying a fourth content in the first video using the image recognition algorithm;
determining the textual communication responsive to the first speech based on the determined goal of the user, the third content and the fourth content; and
providing the textual communication in a language preferred by the user based on the user profile.

13. A system for providing an audio communication via a portable device, comprising:
a processor; and
a memory storing instructions, wherein the processor is configured to execute the instructions such that the processor and memory are configured to:
detect a first speech proximate to the portable device;
generate a first video of the first speech being spoken proximate to the portable device;
identify a geographic location of the portable device;
identify a first content in the first speech using a speech recognition algorithm;
identify a second content in the first video using an image recognition algorithm;
identify a user profile associated with a user of the portable device by using the first content and the second content;
use a predictive analytic model to determine a context using the first content, the second content, and the geographic location;
determine a goal based on the context, wherein the goal represents the user's desired result related to the first speech, the first video and the geographic location;
identify a third content in the first speech using the speech recognition algorithm;
identify a fourth content in the first video using the image recognition algorithm;
determine the audio communication responsive to the first speech based on the determined goal of the user, the third content and the fourth content; and
provide the audio communication in a language preferred by the user based on the user profile.

14. The system of claim 13, wherein the audio communication is a translation of the third content.

15. The system of claim 13, wherein the context is a conference.

16. The system of claim 13, further comprising determining a fifth content using the first video and adjusting the audio communication responsive to the fifth content.

17. The system of claim 16, wherein the fifth content includes a micro-expression of the user.

18. The system of claim 17, wherein the adjusted audio communication includes repeating a portion of the audio communication responsive to the micro-expression.

19. The system of claim 17, wherein the adjusted audio communication includes updating the user profile responsive to the micro-expression.

20. The system of claim 17, wherein the adjusted audio communication includes adjusting a speed of audio communication responsive to the micro-expression.

21. The system of claim 13, wherein the context is a museum, and the goal is to hear a curation of art.

22. The system of claim 13, wherein the context is determined by identifying a speaker of the first content.

23. The system of claim 13, wherein the audio communication is determined by the fourth content being used to supplement distorted audio in the third content.
